(19) United States
(12) Patent Application Publication
(10) Pub. No.: US 2026/0290871 A1
(43) Pub. Date: Sep. 24, 2026

(54) MANIFOLD STRUCTURE IN FUEL CELL

(71) Applicant: HONDA MOTOR CO., LTD., Tokyo (JP)

(72) Inventor: Fumiya ARAI, Wako-shi (JP)

(21) Appl. No.: 19/565,989

(22) Filed: Mar. 13, 2026

(30) Foreign Application Priority Data
Mar. 21, 2025 (JP) 2025-047195

(51) Int. Cl. H01M 8/2483; H01M 8/026; H01M 8/04291; H01M 8/2484

(52) U.S. Cl. CPC H01M 8/2483; H01M 8/026; H01M 8/04291; H01M 8/2484

(57) ABSTRACT

A manifold structure in a fuel cell includes a fuel cell stack formed with a number of power generation cells stacked on each other, and an end unit provided at an end of the fuel cell stack. The structure further includes an exhaust gas passage that communicates through the power generation cells and end unit in a stacking direction to discharge reactant gas within the fuel cell stack to the outside, and a drain pipe that is located in an interior of the passage and drains produced water accumulated in the passage through an inlet on an upstream side thereof toward an outlet on a downstream side thereof. The structure further includes a support portion that supports the outlet of the drainpipe located in the interior of the passage, and a guide portion that is formed on the inner wall and guides reactant gas to flow along the bottom side.

### CROSS-REFERENCE TO RELATED APPLICATION

This application claims the benefit of priority under 35 U.S.C. § 119 to Japanese Patent Application No. 2025-047195 filed on Mar. 21, 2025, the entire contents of which are incorporated herein by reference.

### TECHNICAL FIELD

The present invention relates to a manifold structure in a fuel cell.

### BACKGROUND OF THE INVENTION

Research and development has been conducted over recent years on fuel cells that contribute to energy efficiency, so that more people can secure access to affordable, dependable, sustainable, and advanced energy. A manifold structure in a fuel cell has been provided with an exhaust gas passage penetrating the cell stack in a front-rear direction of a vehicle to discharge reactant gas supplied to a number of power generation cells. In addition, the manifold is provided with a drainpipe, having an inlet and an outlet respectively communicating with the upstream and downstream sides of the exhaust gas passage, at a bottom on a bottom side of an inner wall of the manifold (see Japanese Patent Application Publication No. 2024-126790, for example, which is referred to as Patent Document 1 hereinbelow).

Such a structure causes the produced water accumulated in the exhaust gas passage to be entrained by the reactant gas and discharged when the flow velocity of the reactant gas is high. Such a structure also causes the drainpipe to promote draining, when the flow velocity is low, to reduce possibility of the produced water accumulating on the upstream side of the exhaust gas passage. In addition, a structure is known that has a reduced-diameter section with an exhaust manifold reduced in diameter at around an outlet, as a particular one to promote discharge of produced water, to increase the flow velocity of the reactant gas (see Japanese Patent Application Publication No. 2024-126788, for example, which is referred to as Patent Document 2 hereinbelow). Such a structure increases negative pressure generated in the expanded section following the reduced-diameter section to drain the produced water from the outlet of the drainpipe together with the reactant gas.

### SUMMARY OF THE INVENTION

### Problems to Be Solved

However, if the reactant gas flows upward at around the outlet of the drainpipe due to the shape of the expanded section, the reactant gas flow separates from the bottom surface of the exhaust manifold, to generate a vortex of exhaust flow on the bottom side. This vortex obstructs the produced water flowing along the bottom side. As a result, if produced water accumulates at around the expanded section, there has been possibility of the produced water flowing back toward the exhaust gas passage via the reduced-diameter section when the flow velocity of the reactant gas decreases. Configurations of the prior art have failed to have ideal flow to achieve sufficient drainage performance, as described above, and have a room for further enhancement. The present invention is intended to provide a manifold structure in a fuel cell that is capable of preventing gas flow separation and enhance drainage performance. Then, the present invention is intended to contribute to energy efficiency.

### Solution to Problem

To solve the above problem, a manifold structure in a fuel cell according to the present invention includes a fuel cell stack formed with a number of power generation cells stacked on each other, and an end unit provided at an end of the fuel cell stack. The manifold structure further includes an exhaust gas passage that communicates through the power generation cells and end unit in a stacking direction to discharge reactant gas within the fuel cell stack to the outside. The manifold structure further includes a drainpipe that is located in an interior of the exhaust gas passage and drains produced water accumulated in the exhaust gas passage through an inlet on an upstream side thereof toward an outlet on a downstream side thereof. The manifold structure further includes a support portion that is formed on a bottom side of an inner wall of the exhaust gas passage and supports the outlet of the drainpipe, and a guide portion that is formed on the inner wall and guides reactant gas to flow along the bottom side of the inner wall.

### Advantageous Effects of the Invention

The present invention provides a manifold structure in a fuel cell that is capable of preventing gas flow separation to enhance drainage performance. Then, the present invention contributes to energy efficiency.

### BRIEF DESCRIPTION OF DRAWINGS

FIG. 1 is a side view of a manifold structure in a fuel cell according to an embodiment of the present invention;

FIG. 2 is a perspective view of a collar in an end unit provided at an end of the manifold;

FIG. 3 is a cross-sectional view taken along a line III-III in FIG. 2, illustrating a structure of a reduced-diameter section at the end of the manifold;

FIG. 4 is a cross-sectional view taken along a line IV-IV in FIG. 2, illustrating the structure of the reduced-diameter section;

FIG. 5 is a table showing fluid flow in the manifold, verified by changing an angle of a guide portion; and

FIG. 6 is a side view of the fluid flow in the manifold.

### DETAILS DESCRIPTION

Hereinafter, an embodiment of the present invention is described with reference to the drawings as appropriate. Identical components are denoted by the same reference signs, and duplicate descriptions thereof are skipped.

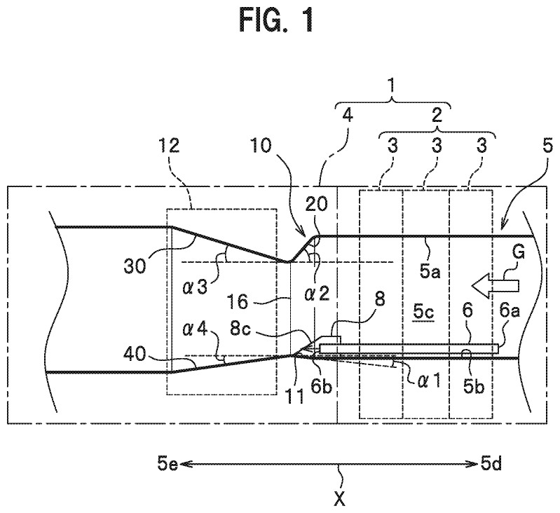

FIG. 1 schematically illustrates a manifold structure in a fuel cell according to the embodiment. FIG. 1 shows components of the fuel cell with virtual lines (dash-dotted lines and dashed lines) and an interior of an exhaust gas passage 5 with solid lines, for the purpose of illustration. A fuel cell 1 includes a fuel cell stack 2 formed with a number of power generation cells 3 stacked on each other, and an end unit 4 provided at an end of the fuel cell stack 2. The end unit 4 in FIG. 1 is a wet end unit where hydrogen gas as fuel gas and air as oxidant gas are supplied or discharged. The wet end unit is paired with a dry end unit mounted on the opposite side of a case (not shown) covering the fuel cell stack 2, to close both ends of the case.

The fuel cell 1 has hydrogen gas and air flown respectively from both sides of a stack of membrane electrode assemblies, each alternately stacked with a separator, of the power generation cells 3. During power generation, produced water W is produced along with exhaust gas. Here, the exhaust gas is described as reactant gas G. The fuel cell 1 is provided with the exhaust gas passage (or manifold) 5 to collect and discharge the reactant gas G from power generation cells 3. The exhaust gas passage 5 communicates through the power generation cells 3 and the end units 4 in a stacking direction X. The exhaust gas passage 5 has a cylindrical collar member 12 provided on a downstream side 5e thereof and communicating with an outlet which is open to a side wall of the end unit 4. The reactant gas G produced within the fuel cell stack 2 flows from an upstream side 5d of the exhaust gas passage 5 toward the downstream side 5e and is discharged to the outside through the outlet.

The fuel cell 1 further includes a drainpipe 6 located in an interior 5c of the exhaust gas passage 5. The drainpipe 6 of the embodiment is formed as a thin tube and extends from an upstream side 5d of the exhaust gas passage 5 toward the downstream side 5e along the lowest recess, curved on a bottom side 5b, of an inner wall 5a of the exhaust gas passage 5. The drainpipe 6 is formed with an inlet 6a which is open to the upstream side 5d of the exhaust gas passage 5 and communicates with an internal space of the exhaust gas passage 5. The drainpipe 6 is also provided, at the opposite end thereof to the inlet 6a, with an outlet 6b which is open to the downstream side 5e of the exhaust gas passage 5.

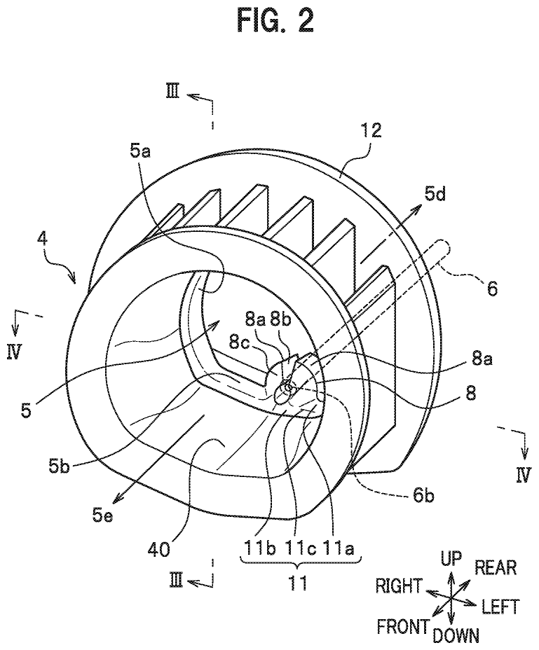

The exhaust gas passage 5 is provided, on the bottom side 5b of the inner wall 5a thereof, with a support portion 8 that supports the outlet 6b of the drainpipe 6. As shown in FIG. 2, the support portion 8 of the embodiment is mainly formed with a pair of right and left locking claws 8a. The locking claws 8a fix the drainpipe 6 at the lowest recess on the bottom side 5b, with the outlet 6b of the drainpipe 6 being held on its outer peripheral surface from both sides, so as to become part in a width direction of the bottom side 5b. The support portion 8 projects upward from the bottom side 5b, within the end unit 4, of the inner wall 5a of the exhaust gas passage 5 toward the space in the exhaust gas passage 5. The pair of locking claws 8a of the support portion 8 each has a spindle shape as a whole. As shown in FIG. 4, the support portion 8 of the embodiment has its width in the lateral direction smaller than that of the bottom side 5b of the exhaust gas passage 5. An upper surface 8c of the support portion 8 is inclined so as to approach the bottom side 5b toward the downstream side 5e of the exhaust gas passage 5. The support portion 8 of the embodiment further includes a groove-like upper slit 8b to facilitate insertion between the right and left locking claws 8a. This further causes the reactant gas G to flow along the bottom side 5b through both sides of the support portion 8. The reactant gas G flowing along the upper surface 8c of the support portion 8 flows toward the bottom side 5b along the inclination. The upper slit 8b also facilitates the reactant gas G flowing therethrough to reduce the extent of contact between the gas and the support portion 8. Thus, the support portion 8 allows the gas to flow smoothly in the exhaust gas passage 5 toward the downstream side 5e, while suppressing turbulence.

The support portion 8 of the embodiment includes the groove-like upper slit 8b between the right and left locking claws 8a. The drainpipe 6 having the outlet 6b inserted between the locking claws 8a is fixed by the support portion 8 along the bottom side 5b of the inner wall 5a of the exhaust gas passage 5. This causes the produced water W accumulated on the upstream side 5d in the interior 5c of the exhaust gas passage 5 to flow into the inlet 6a of the drainpipe 6, then flow through a duct of the drainpipe 6 toward the downstream side 5e and is drained through the outlet 6b into the interior 5c of the exhaust gas passage 5.

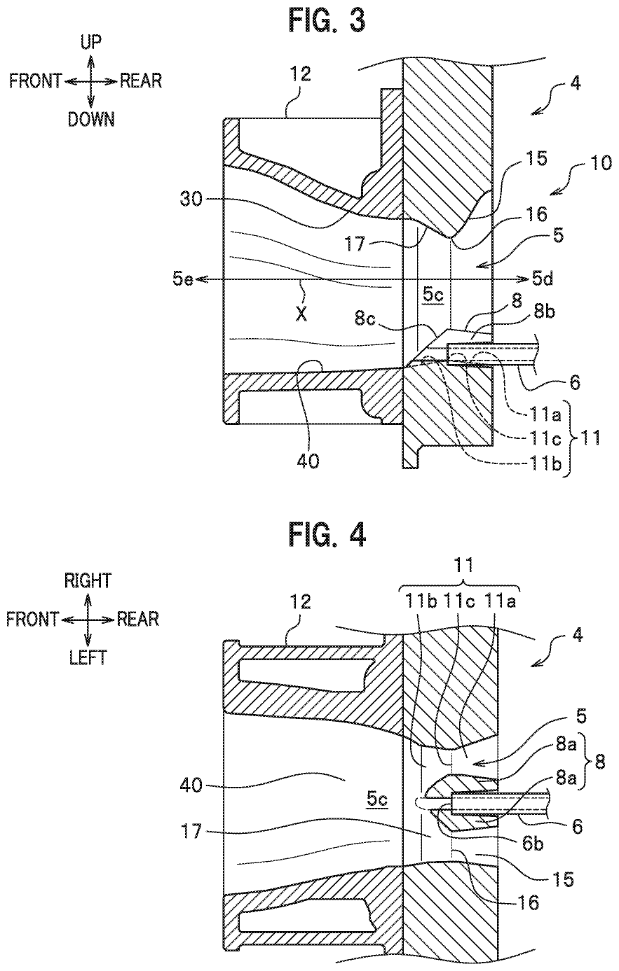

As shown in FIG. 3, the exhaust gas passage 5 of the embodiment has a reduced-diameter section 15 with a minimum diameter portion 16 set at the outlet 6b of the drainpipe 6, and an expanded section 17 with its diameter expanding downstream from the minimum diameter portion 16. The reduced-diameter section 15 and expanded section 17 are provided on the top side of the exhaust gas passage 5. On the one hand, the reduced-diameter section 15 narrows toward the downstream side (front side) 5e in the stacking direction X to have a smaller diameter, thereby increasing the flow velocity of the reactant gas G. On the other hand, the expanded section 17 expands toward the downstream side (front side) 5e in the stacking direction X to have a larger diameter, as shown in FIG. 4, thereby reducing the flow velocity of the reactant gas G and generating negative pressure. The reduced-diameter section 15 and expanded section 17 have the minimum diameter portion 16 provided therebetween in the stacking direction X, which has the smallest internal diameter of the interior 5c. The outlet 6b of the drainpipe 6 for draining the produced water W is then provided at the location of the minimum diameter portion 16 in the stacking direction X.

The fuel cell 1 further includes a guide portion 10 on the inner wall 5a of the exhaust gas passage 5, as shown in FIG. 1. The guide portion 10 guides the reactant gas G flowing through the interior 5c of the exhaust gas passage 5. The guide portion 10 of the embodiment has a first guide surface 11, a second guide surface 20, a third guide surface 30, and a fourth guide surface 40. These guide surfaces of the guide portion 10, such as the first guide surface 11, are each set with an inclination angle relative to the axial direction of the exhaust gas passage 5. This allows the guide portion 10 to guide the reactant gas G passing from the upstream side 5d toward the downstream side 5e in the exhaust gas passage 5 so as to flow along the bottom side 5b of the inner wall 5a. The reactant gas G then flows along the bottom side 5b, so that the guide portion 10 causes the produced water W to efficiently flow toward the downstream side 5e, while preventing gas flow separation of the reactant gas G from the produced water W being drained through the outlet 6b, to enhance drainage capacity.

As shown in FIGS. 1 and 3, the first guide surface 11 of the embodiment has an upstream guide surface 11a and a downstream guide surface 11b. On the one hand, the upstream guide surface 11a has a predetermined first inclination angle α1 that rises toward the downstream side 5e. The first inclination angle α1 of the embodiment in FIG. 1 is set between 0° and 10°, for example, preferably about 9°. On the other hand, the downstream guide surface 11b has a predetermined fourth inclination angle α4 that descends toward the downstream side 5e. The fourth inclination angle α4 of the embodiment is set between 0° and 15°, for example, preferably about 9°. The upstream guide surface 11a and downstream guide surface 11b of the first guide surface 11 have a peak 11c, which is the highest of the first guide surface 11, provided therebetween in the stacking direction X. A position of the outlet 6b is set to a location of the peak 11c. Additionally, the peak 11c of the first guide surface 11 of the embodiment is set lower than the upper surface 8c of the support portion 8, so that the upstream guide surface 11a and downstream guide surface 11b are gently connected (see FIG. 3).

Next, the second guide surface 20 of the guide portion 10 is formed on the top side at the reduced-diameter section 15, opposing the bottom side 5b, of the inner wall 5a. As shown in FIG. 1, the second guide surface 20 of the embodiment has a predetermined second inclination angle α2 that continuously descends toward the downstream side 5e on the upstream side 5d of the minimum diameter portion 16. The second inclination angle α2 of the embodiment is set between 45° and 65°, for example, preferably about 55°. Moreover, the second inclination angle α2 of the second guide surface 20 is set larger than the first inclination angle α1 of the upstream guide surface 11a of the first guide surface 11 set for the opposing bottom side 5b (α1<α2).

Next, the third guide surface 30 formed in the guide portion 10 of the embodiment is formed on the top side at the expanded section 17, opposing the bottom side 5b, of the inner wall 5a. The surface is continuously formed from the minimum diameter portion 16 toward the downstream side so as to rise toward the downstream side 5e. As shown in FIG. 1, the third guide surface 30 of the embodiment has a third inclination angle α3 with respect to the expansion direction set between 15° and 45°, for example, preferably about 26°.

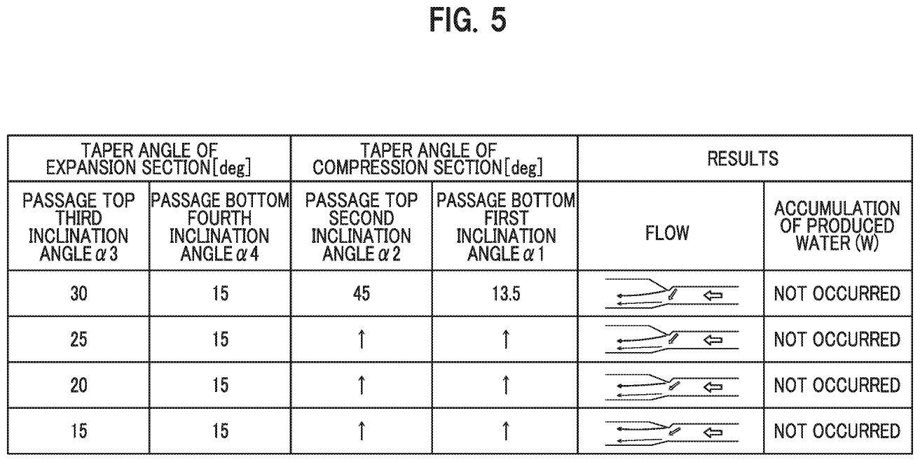

Moreover, the third guide surface 30 has the third inclination angle α3 with respect to the expansion direction set larger than the fourth inclination angle α4 with respect to the expansion direction set for the bottom side 5b of the exhaust gas passage 5 (α4<α3). FIG. 5 shows the results verifying whether flow of the reactant gas G separates from flow of the produced water W by changing the angle of the guide portion 10 formed in the exhaust gas passage 5. The guide portion 10 of the embodiment has the first inclination angle α1 of the first guide surface 11 set to about 13.5°, the second inclination angle α2 of the second guide surface 20 set to about 45°, and the fourth inclination angle α4 of the fourth guide surface 40 set to about 15° in common for all verifications. Then, verification was conducted using the exhaust gas passages 5 in which the third inclination angle α3 of the third guide surface 30 was set to four different angles: about 15°, about 20°, about 25°, and about 30°.

As a result of the verification, it was found that when the second inclination angle α2 on the top side of the compression section is greater than the first inclination angle α1 on the bottom side 5b, and the third inclination angle α3 on the top side of the expansion section is greater than the fourth inclination angle α4 on the bottom side 5b by 5° or more, flow of the reactant gas G did not separate from flow of the produced water W. On the other hand, as the third inclination angle α3 of the third guide surface 30 increased to about 15°, about 20°, about 25°, and about 30°, flow of the reactant gas G separated from the third guide surface 30, having no influence on the flow direction of the reactant gas G guided by the second guide surface 20. Accordingly, it was demonstrated that even when the third inclination angle α3 is set larger than the fourth inclination angle α4, the flow can be maintained without impairing drainage performance.

The embodiment has the third inclination angle α3 set to about 26°, which is larger than the fourth inclination angle α4, having flow of the reactant gas G separated from the third guide surface 30. This ensures sufficient pipe diameter downstream of the guide portion 10. Accordingly, this facilitates flowing of the produced water W without increasing the ventilation resistance of the reactant gas G.

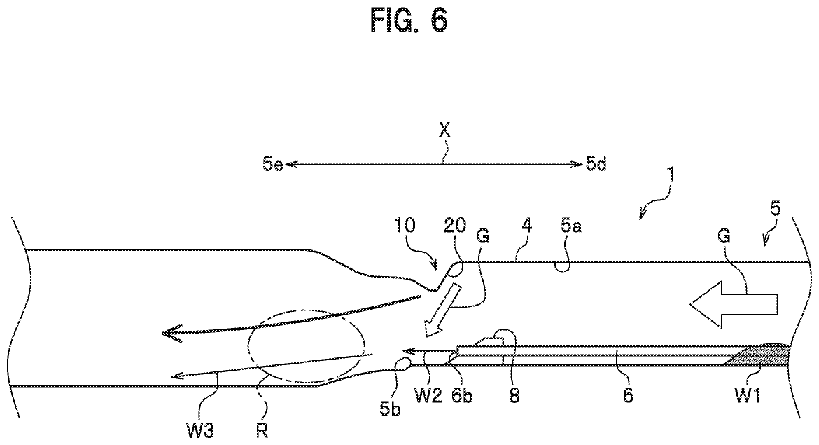

Next, advantageous effects of the manifold structure in the fuel cell 1 of the embodiment is described with reference to FIG. 6. The fuel cell 1 generates electricity when hydrogen gas and air flow respectively from both sides of the membrane electrode assemblies comprising the power generation cells 3, while producing the produced water W along with the reactant gas G. When produced water W1 produced from power generation by the power generation cells 3 accumulates within the interior 5c of the exhaust gas passage 5, produced water W2 drained through the outlet 6b of the drainpipe 6 is guided by the guide portion 10 provided on the inner wall 5a, along the bottom side 5b where the support portion 8 is formed. The gas flow of the reactant gas G2 at around the outlet 6b is discharged by the guide portion 10 together with the produced water W at around the outlet 6b, without separating from the produced water W2. Accordingly, even when flow velocity of reactant gas G1 within the exhaust gas passage 5 decreases, the produced water W is smoothly drained together with the reactant gas G through a downstream region R. This reduces possibility of produced water W3, which has been accumulated in the downstream region R, flowing back toward the upstream side of the exhaust gas passage. The manifold structure in the fuel cell 1 according to the embodiment can then achieve the desired drainage performance.

As described above, the manifold structure in the fuel cell 1 according to the present invention includes the fuel cell stack 2 formed with a number of the power generation cells 3 stacked on each other, and the end unit 4 provided at the end of the fuel cell stack 2. The manifold structure also includes the exhaust gas passage 5 that communicates through the power generation cells 3 and end units 4 in the stacking direction to discharge the reactant gas G within the fuel cell stack 2 to the outside, and the drain pipe 6 that is located in an interior of the exhaust gas passage 5 and drains the produced water W accumulated in the exhaust gas passage 5 through the inlet 6a on the upstream side 5d toward the outlet 6b on the downstream side 5e.

The manifold structure further includes the support portion 8 that is formed on the bottom side 5b of the inner wall 5a of the exhaust gas passage 5 and supports the outlet 6b of the drain pipe 6, and the guide portion 10 that is formed on the inner wall 5a and guides the reactant gas G to flow along the bottom side 5b of the inner wall 5a.

The present invention provides a manifold structure in a fuel cell that prevents gas flow separation and enhances drainage performance. Specifically, the guide portion 10 provided on the inner wall 5a guides the reactant gas G to flow along the bottom side 5b of the inner wall 5a. This causes the produced water W drained through the outlet 6b of the drainpipe 6 is guided along the bottom side 5b on which the support portion 8 is formed. The gas flow of the reactant gas G at around the outlet 6b is discharged together with the produced water W at around the outlet 6b. The produced water W is thus drained smoothly together with the reactant gas G. Accordingly, even when the flow velocity of the reactant gas G decreases, possibility of the accumulated produced water W flowing back toward the upstream side 5d of the exhaust gas passage 5 is reduced. The manifold structure in the fuel cell 1 of the present invention is capable of achieving the desired drainage performance.

In addition, the guide portion 10 has the first guide surface 11 that is formed on the bottom side 5b of the inner wall 5a and guides the reactant gas G so as to flow along the flow direction of the produced water W drained through the outlet 6b. This allows the reactant gas G guided by the first guide surface 11 to be discharged together with the produced water W in the same direction.

Further, the upstream and downstream guide surfaces 11a and 11b of the first guide surface 11 of the embodiment are continuously formed from the upstream side 5d toward the downstream side 5e, with the position of the outlet 6b of the drainpipe 6 as the peak 11c. And the first inclination angle α1 of the upstream guide surface 11a and the fourth inclination angle α4 of the downstream guide surface 11b are each set to a gentle slope of about 9°, with the position of the outlet 6b of the drainpipe 6 as the highest peak 11c. The structure thus allows the produced water W to be smoothly drained, without impairing the throttling effect by the reduced-diameter section 15.

Still further, the exhaust gas passage 5 has the reduced-diameter section 15 with the minimum diameter portion 16 set at the outlet 6b of the drainpipe 6. The guide portion 10 also has the second guide surface 20 formed on the top side, opposing the bottom side 5b, of the inner wall 5a and continuing to the minimum diameter portion 16 from the upstream side 5d of the minimum diameter portion 16. And the second guide surface 20 has the second inclination angle α2 with respect to a reduced-diameter direction set larger than the first inclination angle α1 with respect to the reduced-diameter direction set for the bottom side 5b.

This allows the reactant gas G flowing through the exhaust gas passage 5 and passing the minimum diameter portion 16 of the reduced-diameter section 15 to be guided along the second guide surface 20, having the second inclination angle α2 with respect to the reduced-diameter direction set larger than the first inclination angle α1 with respect to the reduced-diameter direction set for the bottom side 5b, and to flow toward the opposing bottom side 5b on which the outlet 6b of the drain pipe 6 is provided. The produced water W drained through the outlet 6b of the drainpipe 6 is thus pressed toward the bottom side 5b, making its flow even less likely to separate, and efficiently drained together with the reactant gas G.

Still further, the exhaust gas passage 5 has the reduced-diameter section 15 with the minimum diameter portion 16 set at the outlet 6b of the drainpipe 6 and the expanded section 17 that expands downstream from the minimum diameter portion 16. The guide portion 10 has the third guide surface 30 formed on the top side, opposing the bottom side 5b, of the inner wall 5a and continuing downstream from the minimum diameter portion 16. And the third guide surface 30 has the third inclination angle α3 with respect to the expansion direction set larger than the fourth inclination angle α4 with respect to the expansion direction set for the bottom side 5b.

As a result, the reactant gas G passing the minimum diameter portion 16 of the reduced-diameter section 15 and flowing toward the downstream side 5e is guided so as to be separated from, without flowing along, the third guide surface 30, which has the third inclination angle α3 with respect to the expansion direction set larger than an equivalent on the bottom side 5b, and readily flows toward the outlet 6b of the drain pipe 6. The structure thus achieves practically useful advantageous effects of preventing gas flow separation, without influence on discharging the reactant gas G, to enhance drainage performance.

The present invention is not limited to the above-described embodiment and can be variously modified. The above-described embodiment is merely an example for easy understanding of the present invention and is not necessarily limited to one having all the described configurations. Part of the configuration of one embodiment may be replaced, or added, with a configuration of another embodiment. Part of a configuration of an embodiment may be deleted, or added and replaced with other configurations. Possible modifications to the above embodiment include the following examples.

The manifold structure in the fuel cell 1 of the embodiment has the support portion 8 projecting from the bottom side 5b, within the end unit 4, of the inner wall 5a of the exhaust gas passage 5 and fixing the outlet 6b of the drainpipe 6. However, the outlet 6b of the drain pipe 6 need not be within the end unit 4, and may be supported by the support portion 8 at any position within the exhaust gas passage 5, as long as that is on the bottom side 5b of the inner wall 5a along which the reactant gas G guided by the guide portion 10 flows. Besides, the drainpipe 6, support portion 8, and guide portion 10 are not particularly limited in number, shape, and material.

### LIST OF REFERENCE SIGNS

1: fuel cell, 2: fuel cell stack, 3: power generation cell, 4: end unit, 5: exhaust gas passage, 5a: inner wall, 5b: bottom side, 5d: upstream side, 5e: downstream side, 6: drainpipe, 6a: inlet, 6b: outlet, 8: support portion, 10: guide portion, G: reactant gas, and W: produced water.

What is claimed is:

1. A manifold structure in a fuel cell, the structure comprising:
a fuel cell stack formed with a number of power generation cells stacked on each other;
an end unit provided at an end of the fuel cell stack;
an exhaust gas passage that communicates through the power generation cells and end unit in a stacking direction to discharge reactant gas within the fuel cell stack to the outside;
a drainpipe that is located in an interior of the exhaust gas passage and drains produced water accumulated in the exhaust gas passage through an inlet on an upstream side thereof toward an outlet on a downstream side thereof;
a support portion that is formed on a bottom side of an inner wall of the exhaust gas passage and supports the outlet of the drainpipe; and
a guide portion that is formed on the inner wall and guides reactant gas to flow along the bottom side of the inner wall.

2. The manifold structure in a fuel cell according to claim 1, wherein
the guide portion has a first guide surface formed on a bottom side of the inner wall to guide the reactant gas so as to flow along a flow direction of the produced water drained through the outlet.

3. The manifold structure in a fuel cell according to claim 1, wherein
the exhaust gas passage has a reduced-diameter section with a minimum diameter portion set at the outlet of the drainpipe,
the guide portion has a second guide surface formed on a top side, opposing the bottom side, of the inner wall and continuing to the minimum diameter portion from an upstream side of the minimum diameter portion, and
the second guide surface has an inclination angle with respect to a reduced-diameter direction set larger than that set for a corresponding surface on the bottom side.

4. The manifold structure in a fuel cell according to claim 1, wherein
the exhaust gas passage has a reduced-diameter section with a minimum diameter portion set at the outlet of the drainpipe, and an expanded section that expands downstream from the minimum diameter portion,
the guide portion has a third guide surface formed on a top side, opposing the bottom side, of the inner wall and continuing downstream from the minimum diameter portion, and
the third guide surface has an inclination angle with respect to an expansion direction set larger than that set for a corresponding surface on the bottom side.
